(19) United States
(12) Patent Application Publication
(10) Pub. No.: US 2015/0328812 A1
(43) Pub. Date: Nov. 19, 2015

(54) METHOD OF PURGING FOR AN INJECTION MOLDING MACHINE

(71) Applicant: NISSEI PLASTIC INDUSTRIAL CO., LTD., Hanishina-gun (JP)

(72) Inventors: Makoto KOZUKA, Hanishina-gun (JP); Kazuo ANZAI, Hanishina-gun (JP)

(73) Assignee: NISSEI PLASTIC INDUSTRIAL CO., LTD., Hanishina-gun (JP)

(21) Appl. No.: 14/714,898

(22) Filed: May 18, 2015

(30) Foreign Application Priority Data
May 19, 2014 (JP) 2014-103741

(51) Int. Cl. B29C 45/17

(52) U.S. Cl. CPC B29C 45/1755

(57) ABSTRACT

A switching purging step (S6 to S13) is provided as a purging process step. The switching purging step (S6 to S13) includes a former purging step (S7) and a latter purring step (S9 to S13) executed after the former purging step (S7). The former purging step (S7) includes introduction of a second molding material R2 into an injection device 1i, and metering operation and purging operation repeated a given number of times. The latter purging step (S9 to S13) includes a metering purging process (S9) and an empty purging process (S11) performed a number of times corresponding to a given repeat count. The metering purging process (S9) includes metering operation with a metering value smaller than that of the former purging step (S7) and purging operation repeated a given number of times. The empty purging process (S11) is performed after the metering purging process (S9). The empty purging process (S11) includes empty purging operation of making a screw retreat and then advance while the screw is not rotated and is repeated a given number of times.

### TECHNICAL FIELD

This invention relates to a method of purging for an injection molding machine suitably employed for switching a resin material to be used for molding from a first molding material to a second molding material different from the first molding material.

### BACKGROUND ART

In the case of a general injection molding machine (injection device), to produce a molded article of a different material or in a different color continuously, a first molding material used in previous production needs to be changed to a second molding material to be used in subsequent production. Thus, for this resin change, a purging process step is executed after the previous production has finished. In the purging process step generally executed, residual resin in a heating tube (first molding material) is discharged and then the second molding material to be used for the subsequent production is supplied. Thus, the second molding material is required to not contain the residue of the first molding material.

Purging methods conventionally known to include the aforementioned purging process step include a method of changing the resin and/or color of resin employed in an injection molding machine disclosed in patent literature 1 and a purging method employed in an injection molding machine disclosed in patent literature 2. The method disclosed in patent literature 1 enables change of the type or color of resin through work conducted in a mode similar to normal molding operation. This method is intended to reduce a load on a worker and save manpower. More specifically, the following resin changing molding cycle is performed repeatedly multiple times. With a tip of an injection cylinder abutting on an inlet of a mold for resin, former resin in the injection cylinder is discharged into the mold. Then, new resin is supplied into the injection cylinder. While the new resin is plasticized, an injection screw is made to retreat. Then, the new resin is accumulated in a part near a tip of the injection screw. The injection screw makes high-speed inching injection by repeating forward inching movement and backward inching movement of a stroke shorter than that of the forward inching movement multiple times until the injection screw reaches a limit position of forward movement, thereby pouring the new resin into the mold. Then, a molded article is taken out of the mold. After the resin changing molding cycle is finished, a switch is made to injection molding with the new resin.

The method disclosed in patent literature 2 is intended to enable automatic selection of a suitable condition for controlling a resin changing operation. More specifically, to change resin from a resin material used in a previous molding operation to a resin material to be used in a subsequent molding operation, one condition for controlling the resin changing operation is selected from multiple conditions for controlling the resin changing operation prepared in advance based on a resin condition for the resin material (a resin condition defined by a combination of the type of a raw material, the type of a melting temperature, and the type of a color for resin, for example) used in the previous molding operation and a resin condition for the resin material to be used in the subsequent molding operation. The resin changing operation is controlled using the selected condition.

### SUMMARY OF INVENTION

### Technical Problem

The aforementioned conventional purging methods leave the following problems unsolved.

First, in the purging process step, the residue of the first molding material cannot be discharged completely though just a single purging process. For this reason, this residue is generally discharged by being mixed into the second molding material to be supplied next. Thus, discharging the residue of the first molding material as efficiently and as effectively as possible becomes an important issue in terms of reducing material cost and shortening a purging processing time to increase production efficiency. However, no purging technique developed in this approach can be found in any conventional purging method. Conventional purging methods cannot be considered to be satisfactory methods in terms of discharging the first molding material efficiently and effectively.

Second, a purging condition, specifically a temperature condition or an operating condition (a purging speed or a metering rotation count, for example) for a purging process cannot always be optimized satisfactorily. Thus, the actual situation is that a purging condition is set by following various types of molding conditions for a production step. Thus, room for further improvement has been left in teens of suppressing the occurrence of an unnecessary defective item to reduce material cost and shorten a purging time further by optimizing a purging condition for the purging process step.

This invention is intended to provide a method of purging for an injection molding machine that solves the aforementioned problems in the background art.

### Solution to Problem

To solve the aforementioned problems, this invention is intended for a method of purging for an injection molding machine 1 employed for making a switch from a first molding material R1 to a second molding material R2 different from the first molding material R1 by discharging a residue of the first molding material R1 from an injection device 1i and supplying the second molding material R2. The purging method includes a switching purging step (S6 to S13) as a purging process step executed after the residual first molding material R1 is discharged in advance from the injection device 1i by a certain method. The switching purging step (S6 to S13) includes a former purging step (S7) and latter purging steps (S9 to S13) executed after the former purging step (S7). The former purging step (S7) includes introduction of the second molding material R2 into the injection device 1i, and metering operation and purging operation repeated a given number of times. The latter purging steps (S9 to S13) include metering purging process (S9) and empty purging process (S11) performed a number of times corresponding to a given repeat count. The metering purging process (S9) includes metering operation with a metering value smaller than that of the former purging step (S7) and purging operation repeated a given number of times. The empty purging process (S11) is performed after the metering purging process (S9) and includes empty purging operation of making a screw retreat and then advance while the screw is not rotated. The empty purging operation is repeated a given number of times.

### Advantageous Effects of Invention

Thus, the method of purging for the injection molding machine 1 of this invention achieves the following significant effects.

(1) The purging method includes the switching purging steps (S6 to S13). The switching purging steps (S6 to S13) include the former purging step (S7) and the latter purring step (S9 to S13) executed after the former purging step (S7). The former purging step (S7) includes introduction of the second molding material R2 into the injection device 1i, and the subsequent metering operation and purging operation repeated a given number of times. The latter purging step (S9 to S13) includes the metering purging process (S9) and the empty purging process (S11) performed a number of times corresponding to the given repeat count. The metering purging process (S9) includes the metering operation with a metering value smaller than that of the former purging step (S7) and the purging operation repeated a given number of times. The empty purging process (S11) is performed after the metering purging process (S9) and includes the empty purging operation of making the screw retreat and then advance while the screw is not rotated. The empty purging operation is repeated a given number of times. Thus, the residue of the first molding material R1 can be discharged efficiently and effectively from the injection device 1i. This achieves reduction in a purging processing time and contributes to reduction in material cost and enhancement of production efficiency.

(2) According to a preferred aspect, regarding a set condition relating to a temperature in the switching purging step, a rear side heating temperature Tr for a site including a heating tube middle section 3m and a heating tube rear section 3r of the injection device 1i is set to be lower than a front side heating temperature Tf for a front side including a heating tube front section 3f This allows optimization of a purging condition in terms of a temperature condition. This suppresses the occurrence of an unnecessary defective item, thereby reducing material cost further and shortening a purging processing time further.

(3) According to a preferred aspect, the front side heating temperature Tf is set in a range from equal to or more than a processing temperature for resin relating to the first and second molding materials R1 and R2 to equal to or less than a decomposition temperature for the resin. Thus, the front side heating temperature Tf can be set to be “from +T1 to +T2 [° C.]” relative to the processing temperature Tp, for example. This contributes to easy setting of the front side heating temperature Tf while achieving a more realistic and more accurate temperature setting. As a result, the heating temperature for the front side of the heating tube 3 can be optimized more desirably.

(4) According to a preferred aspect, the rear side heating temperature Tr is set to be the same as a melting point of the resin relating to the first and second molding materials R1 and R2 or more. Thus, the rear side heating temperature Tr can be set to be “from +T3 to +T4[° C.]” relative to the melting point. This contributes to easy setting of the rear side heating temperature Tr while achieving a more realistic and more accurate temperature setting. As a result, the heating temperature for the rear side of the heating tube 3 can be optimized more desirably.

(5) According to a preferred aspect, a metering rotation count Np for the metering operation in the switching purging step (S6 to S13) is set at a speed higher than that of a metering rotation count Ns set for molding. This particularly contributes to optimization of the metering rotation count Np for the metering operation. Thus, the residue of the first molding material R1 mixed into the second molding material R2 can be discharged efficiently and effectively in terms of the metering rotation count Np.

(6) According to a preferred aspect, a purging speed Vp for the purging operation in the switching purging step (S6 to S13) is set to be higher than a purging speed Vs set for molding. This particularly contributes to optimization of the purging speed Vp for the purging operation. Thus, the residue of the first molding material R1 mixed into the second molding material R2 can be discharged efficiently and effectively in terms of the purging speed Vp.

(7) According to a preferred aspect, in the latter purging step (S9 to S13), a backward stroke Xs for the empty purging process is set to be longer than a metering stroke Xm for the metering purging process (S9). This particularly contributes to optimization of the backward stroke Xs for the empty purging operation. Thus, the residue of the first molding material R1 mixed into the second molding material R2 can be discharged efficiently and effectively in terms of performing the empty purging operation.

(8) According to a preferred aspect, for discharge of the first molding material R1 remaining in the injection device 1i, discharge process is performed through the material discharging step under a set purging condition. Thus, the process of discharging the first molding material R1 can be performed easily by a commonly-used automatic purging process before the switching purging step (S6 to S13) is executed.

(9) According to a preferred aspect, an intermediate material is introduced after the material discharging step is finished and before the second molding material R2 is supplied. This can enhance discharge performance and switching efficiency further resulting from switching between the first and second molding materials R1 and R2.

(10) According to a preferred aspect, in the purging process step, a first setting display part Dpa or Dpae corresponding to the material discharging step (S4) and a second setting display part Dpb or Dpbe corresponding to the switching purging steps (S6 to S13) are displayed on a setting screen Dp or Dpe. Thus, setting corresponding to the material discharging step (S4) and setting corresponding to the switching purging steps (S6 to S13) can be made independently. This enables more flexible setting of a mode of process in the purging process step, thereby enhancing convenience and usability from a user's viewpoint.

(11) According to a preferred aspect, at least one or more of a resin selecting part 41 including a choice for the intermediate material, a temperature display part 42, and a purging mode selection key 43 is displayed on the setting screen Dpe in addition to the first and second setting display parts Dpae and Dpbe. As a result, various settings can be made and usage can be offered in various ways. As an example, an optimal heating temperature determined based on a combination of the first molding material R1, the intermediate material, and the second molding material R2 selected in the resin selecting part 41 can be read from a database prepared in advance and displayed in the temperature display part 42. Further, the type of combination to be used can be selected with the purging mode selection key 43.

### BRIEF DESCRIPTION OF DRAWINGS

FIG. 1 is a flowchart for explaining the steps of a procedure of a purging method according to a preferred embodiment of this invention;

FIG. 2 is a block diagram showing a driving system and a control system of an injection device of an injection molding machine that can implement this purging method;

FIG. 3 shows a setting screen used in a purging process step of this purging method;

FIG. 4(a) is a first schematic view for explaining the validity of this purging method;

FIG. 4(b) is a second schematic view for explaining the validity of this purging method;

FIG. 4(c) is a third schematic view for explaining the validity of this purging method;

FIG. 5(a) is an evaluation table relating to a verification test to become a basis for this purging method;

FIG. 5(b) is a different evaluation table relating to the different verification test to become a basis for this purging method;

FIG. 5(c) is a different evaluation table relating to the verification test to become a basis for this purging method;

FIG. 6(a) is an explanatory view of a purging condition optimized based on this verification test;

FIG. 6(b) is an explanatory view of a different purging condition optimized based on this verification test; and

FIG. 7 shows a setting screen used in a purging process step of a purging method according to a modified embodiment of this invention.

### DESCRIPTION OF EMBODIMENTS

A preferred embodiment of this invention is described below in detail based on the drawings. The accompanying drawings are not to specify this invention but to facilitate understanding of this invention. In order to avoid making this invention unclear, well-known parts will not be described in detail.

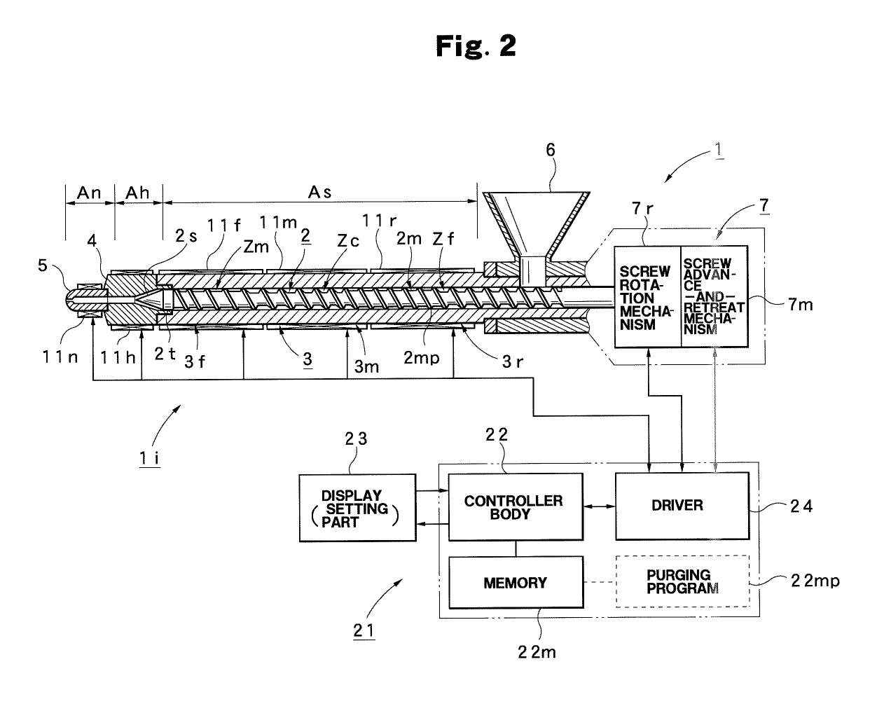

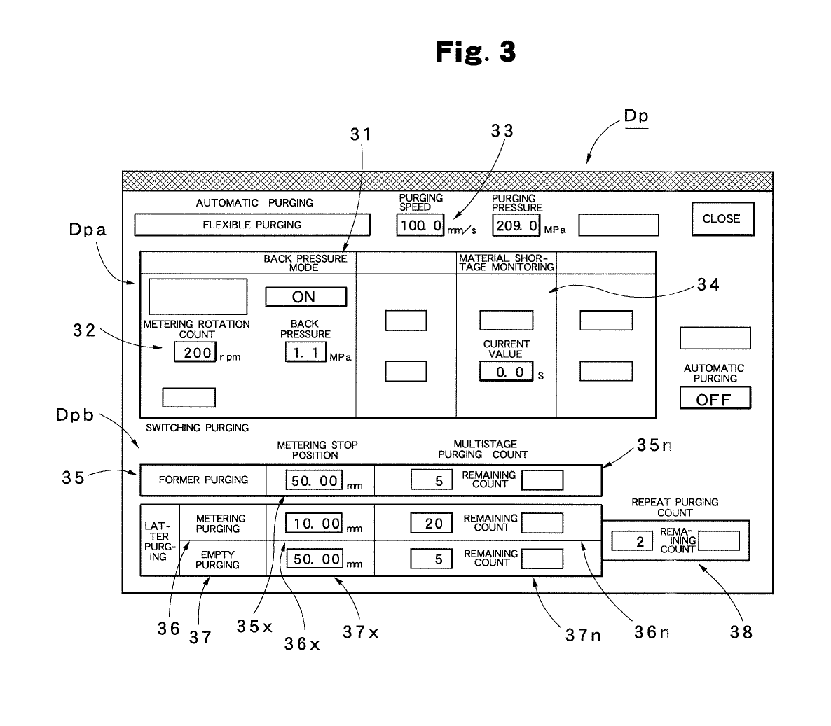

The structure of an injection molding machine 1 that can implement a purging method of this embodiment is described first by referring to FIGS. 2 and 3.

Referring to FIG. 2, 1 shows an injection molding machine, particularly an injection device 1i. A clamping device is not shown in FIG. 2. The injection device 1i includes a heating tube indicated by a 3. The heating tube 3 has a front end to which a nozzle 5 is fixedly attached through a head 4. A hopper 6 is provided over the rear end of the heating tube 3. The nozzle 5 has the function of injecting molten resin inside the heating tube 3 into a mold. The hopper 6 has the function of supplying a resin material (a first molding material R1 and a second molding material R2) into the heating tube 3.

The inside of the heating tube 3 is loaded with a screw 2 in a manner that allows the screw 2 to rotate freely and advance and retreat freely. The screw 2 includes a screw body 2m provided with a helical flight 2mp. The screw body 2m has a front end where a torpedo 2t and a screw tip 2s are arranged. The screw body 2m has a metering zone Zm, a compression zone Zc, and a feed zone Zf arranged in this order from the front side toward the rear side. The screw 2's rear end is coupled to a screw driver 7. The screw driver 7 includes a screw rotation mechanism 7r for rotating the screw 2 and a screw advance-and-retreat mechanism 7m for making the screw 2 advance and retreat. The screw rotation mechanism 7r and the screw advance-and-retreat mechanism 7m can be driven by any system such as a hydraulic system using a hydraulic circuit or an electric system using an electrically-driven motor.

The heating tube 3 has a heating tube front section 3f, a heating tube middle section 3m, and a heating tube rear section 3r arranged in this order from the front side toward the rear side. These sections 3f, 3m, and 3f have outer circumferential surfaces provided with a front heater 11f, a middle heater 11m, and a rear heater 11r respectively. Likewise, the head 4 and the nozzle 5 have outer circumferential surfaces provided with a head heater 11h and a nozzle heater 11n respectively. Each of these heaters 11f, 11m, 11r, 11h, and 11n can form a band heater, for example.

21 shows a molding machine controller responsible for control of the entire injection molding machine 1. The molding machine controller 21 includes a controller body 22 with a computer function achieved by providing a CPU and hardware such as an accompanying internal memory 22m inside the controller body 22. The controller body 22 is connected to a display 23 and a driver 24. In this case, the display 23 is accompanied by a touch-panel setting part and can be used for making various settings. The driver 24 is connected to the aforementioned screw rotation mechanism 7r and screw advance-and-retreat mechanism 7m. The driver 24 is further connected to each of the heaters 11f, 11m, 11r, 11h, and 11n. As a result, the controller body 22 can control driving of the screw rotation mechanism 7r and the screw advance-and-retreat mechanism 7m and current conduction of each of the heaters 11f, 11m, 11r, 11h, and 11n through the driver 24.

In this way, the molding machine controller 21 contains a human machine interface (HMI) control system and a programmable logic controller (PLC) control system and the internal memory 22m stores a PLC program and an HMI program. The PLC program is software prepared to achieve sequential operations of the injection molding machine 1 in various steps and monitoring of the injection molding machine 1, for example. The HMI program is software prepared to achieve setting of an operation parameter for the injection molding machine 1, display of the parameter, and display of data about monitored operation of the injection molding machine 1, for example. The software includes software to realize processing relating to the purging method of this embodiment, specifically a purging program 22mp.

FIG. 3 shows a setting screen Dp appearing on the display 23 used in a purging process step. The setting screen Dp has a first setting display part Dpa arranged in the upper half corresponding to a material discharging step, and a second setting display part Dpb arranged in the lower half corresponding to a switching purging step. As described in detail later, the material discharging step is mainly intended to discharge the first molding material R1 from the injection device 1i. The switching purging step has a former purging step and a latter purging step. The switching purging step is intended to introduce the second molding material R2 and to mainly make the second molding material R2 useable.

The first and second setting display parts Dpa and Dpb can be prepared as independent setting display parts corresponding to the material discharging step and the switching purging step respectively. Alternatively, the first and second setting display parts Dpa and Dpb can be prepared such that they can be shared with each other. In this example, setting in the material discharging step can be done in the first setting display part Dpa and main setting in the switching purging step can be done in the second setting display part Dpb. Some setting, specifically some purging condition to be shared between these steps can be made in a back pressure mode setting part 31, a metering rotation count setting part 32, a purging speed setting part 33, and a material shortage monitoring setting part 34 in the first setting display part Dpa, for example.

The second setting display part Dpb includes a former purging step setting part 35 used in the former purging step, and a metering purging process setting part 36 and empty purging process setting part 37 used in the latter purging step. The former purging step setting part 35 includes a metering stop position (metering value) setting part 35x and a purging count setting part 35n. The metering purging process setting part 36 includes a metering stop position (metering value) setting part 36x and a purging count setting part 36n. The empty purging process setting part 37 includes a metering stop position (metering value) setting part 37x and a purging count setting part 37n. 38 shows a part for setting a count for the latter purging step, specifically a part for setting a repeat count for the entirety of the metering purging processes and empty purging processes.

As described above, the setting screen Dp used for the purging process step includes the first setting display part Dpa corresponding to the material discharging step and the second setting display part Dpb corresponding to the switching purging step. Thus, setting corresponding to the material discharging step and setting corresponding to the switching purging step can be done independently. This enables more flexible setting of a mode of process in the purging process step, thereby advantageously enhancing convenience and usability from a user's viewpoint.

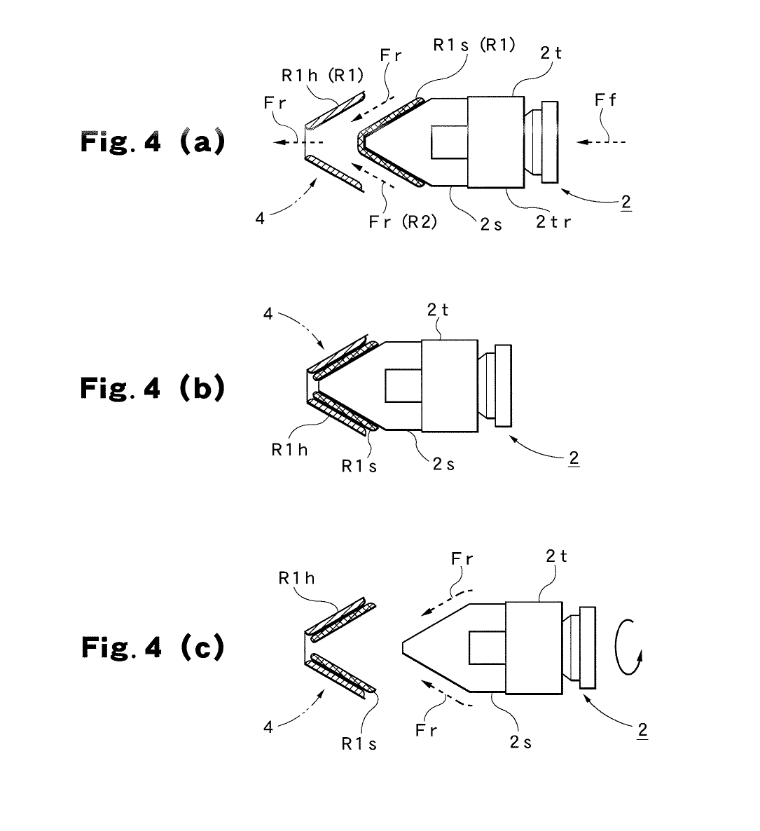

A verification test to become a basis for the purging method of this embodiment conducted by using the injection molding machine 1 is described next by referring to FIGS. 4 to 6.

The verification test was conducted under the assumption of resin change, specifically color change of switching from the first molding material R1 to the second molding material R2 by discharging the first molding material R1 remaining in the heating tube 3 and then supplying the second molding material R2 different from the first molding material R1. For this reason, polypropylene resin colored in black was used as the first molding material R1 and colorless polypropylene resin was used as the second molding material R2.

First, 2 [kg] of the first molding material R1 was introduced from the hopper 6 into the heating tube 3. Then, the first molding material R1 was discharged by a commonly-used automatic purging process (material discharging step). Specifically, purging process was performed first repeatedly five times. According to this purging process, metering of making the screw 2 retreat by 50 [mm] (metering value) was performed and then the screw 2 was made to advance. Next, purging process was performed repeatedly until discharge of the first molding material R1 was completed. According to this purging process, metering of making the screw 2 retreat by 10 [mm] (metering value) was performed and then the screw 2 is made to advance. Other purging conditions include a purging speed set at 10 [mm/s] and a metering rotation count set at 100 [rpm]. The aforementioned material discharging step is not always required to be executed by an automatic purging process. The first molding material R1 can be discharged by any method. As an example, a production step may continue until the first molding material R1 becomes empty or the first molding material R1 may be discharged manually.

After the automatic purging process finished, the second molding material R2 was introduced from the hopper 6 into the heating tube 3. Then, the switching purging step to become a principal part of the purging method of this embodiment was executed by changing purging conditions. After the switching purging step ended under corresponding purging conditions, the screw 2 was taken out of the heating tube 3 and the state of the residual first molding material R1 was checked visually. In the switching purging step, the second molding material R2 at least of an amount required for conducting the verification test was introduced. Then, the procedure of the aforementioned automatic purging process was basically followed during setting of a different purging condition. The different purging conditions include “heating temperature,” “purging speed,” “metering rotation count,” and “presence or absence of empty purging.”

In this case, the former purging step was executed first. In the former purging step, purging process was repeated five times. According to this purging process, metering of making the screw 2 retreat by 50 [mm] (metering value) was performed and then the screw 2 was made to advance. The latter purging step was executed after the former purging step. In the latter purging step, a series of purging operations was performed a number of times corresponding to a given repeat count. The series of purging operations includes metering purging process performed repeatedly a given number of times set as the situation demands and empty purging process performed repeatedly thereafter a given number of times set as the situation demands. According to the metering purging process, metering of making the screw 2 retreat by 10 [mm] (metering value) was performed and then the screw 2 was made to advance. According to the empty purging process, the screw 2 is made to retreat by a given stroke and is then made to advance while the screw 2 is not rotated. A purging speed was set at 10 [mm/s] and a metering rotation count was set at 100 [rpm].

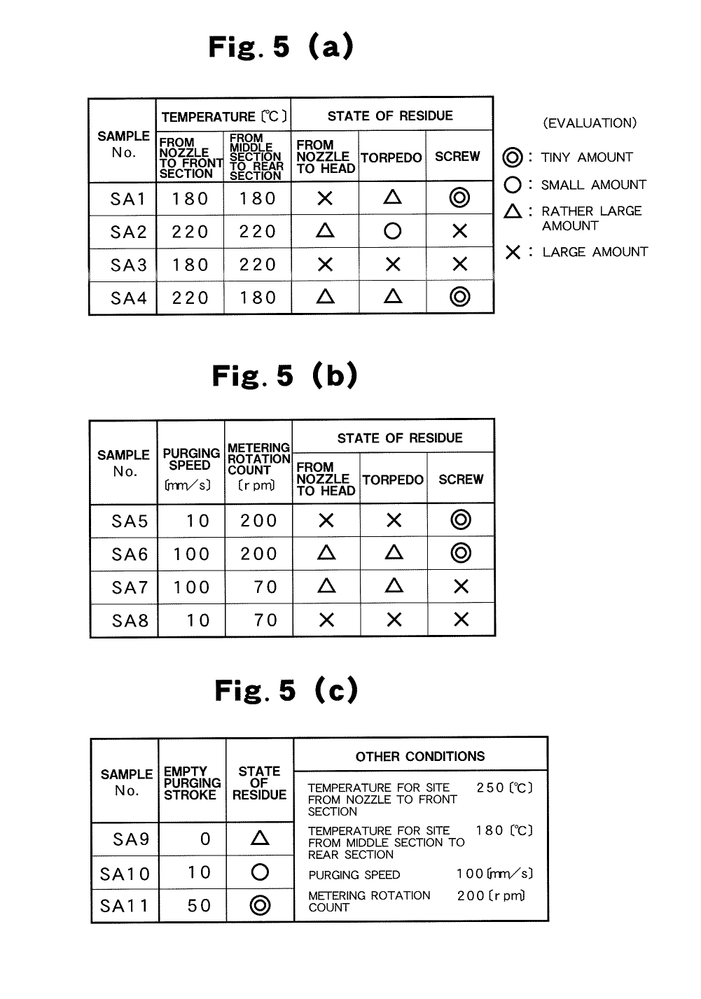

FIGS. 5(a) to 5(c) show results of the verification test. FIG. 5(a) shows results of the verification in terms of “heating temperature.” In this case, four types of samples including a sample No. SA1, a sample No. SA2, a sample No. SA3, and a sample No. SA4 were used and the effect of a heating temperature was considered based on a combination of a heated site and the temperature. Referring to the sample No. SA1 in FIG. 5(a), for example, a heating temperature for a site from the nozzle 5 to the heating tube front section 3f was set at 180[° C.] and that for a site from the heating tube middle section 3m to the heating tube rear section 3r was set at 180[° C.]. A combination of heating temperatures for these sites was changed for sample Nos. SA2 to SA4.

After the aforementioned purging process had finished, the screw 2 was taken out of the heating tube 3 and a residual amount was checked visually. A degree of the residue was evaluated as “⊚” showing a tiny residual amount, “o” showing a small residual amount, “Δ” showing a rather large residual amount, and “X” showing a large residual amount. A heating temperature set for molding of the first molding material R1 was set at 220[° C.] in each case. As clearly seen from FIG. 5(a), the sample No. SA4 showed the most favorable result. By referring to the other samples, setting a heating temperature Tr for the site from the heating tube middle section 3m to the heating tube rear section 3r at a temperature (180[° C.]) lower than the temperature (220[° C.]) set for molding was confirmed to be desirable. Meanwhile, setting a heating temperature Tf for the site from the nozzle 5 to the heating tube front section 3f at a temperature (180[° C.]) lower than the temperature (220[° C.]) set for molding was confirmed not to be desirable.

Thus, to eliminate the residue of the first molding material R1 more readily, the heating temperature Tr for a site including the heating tube middle section 3m and the heating tube rear section 3r is set to be lower than the heating temperature set for molding of the first molding material R1, specifically to be lower than the front side heating temperature Tf. In this case, in consideration of resin properties of the first molding material R1 and those of the second molding material R2, the rear side heating temperature Tr can be set to be the same as a melting point of resin relating to the first molding material R1 or more. Thus, the rear side heating temperature Tr can be set to be “from +5 to +15[° C.]” relative to the melting point, for example. This contributes to easy setting of the rear side heating temperature Tr while achieving more realistic and more accurate temperature setting. As a result, the heating temperature for the rear side of the heating tube 3 can advantageously be optimized more desirably.

The front side heating temperature Tf for the site from the nozzle 5 to the heating tube front section 3f, specifically, the heating temperature Tf for a front side including the heating tube front section 3f is set not to be lower than the heating temperature set for molding of the first molding material R1. In particular, in consideration of resin properties of the first molding material R1 and those of the second molding material R2, the front side heating temperature Tf can be set in a range from a processing temperature Tp for the resin relating to the first molding material R1 to not higher than a decomposition temperature Td for this resin. Thus, the front side heating temperature Tf can be set to be “from +15 to +25[° C.]” relative to the processing temperature Tp, for example. This contributes to easy setting of the front side heating temperature Tf while achieving more realistic and more accurate temperature setting. As a result, the heating temperature for the front side of the heating tube 3 can advantageously be optimized more desirably.

FIG. 5(b) shows results of the verification in terms of “purging speed” and “metering rotation count.” In this case, four types of samples including a sample No. SA5, a sample No. SA6, a sample No. SA7, and a sample No. SA8 were used, and the effect of these items was considered based on a combination of “purging speed” and “metering rotation count.” Referring to the sample No. SA5 in FIG. 5(b), for example, a purging speed was set at 10 [mm/s] and a metering rotation count was set at 200 [rpm]. A combination of a purging speed and the dimension of a metering rotation count was changed for the samples No. SA6 to SA8. Like in the case of FIG. 5(a) referred to previously, the front side heating temperature Tf and the rear side heating temperature Tr were set at 220[° C.] and 180[° C.] respectively.

After the aforementioned purging process had finished, the screw 2 was taken out of the heating tube 3 and a residual amount was checked visually. A purging speed Vs and a metering rotation count Ns set for molding of the first molding material R1 were set at 10 [mm/s] and 100 [rpm] respectively. As a result, as clearly seen in FIG. 5(b), the sample No. SA6 showed the most favorable result. By referring to the other samples, setting a purging speed at 100 [mm/s] was confirmed to be desirable. Setting a metering rotation count at 200 [rpm] was also confirmed to be desirable.

Thus, to eliminate the residue of the first molding material R1 more readily, it is desirable that a metering rotation count Np for metering operation be set at a speed higher than that of the metering rotation count Ns set for molding. This setting particularly contributes to optimization of the metering rotation count Np for metering operation. Thus, a residue of the first molding material R1 mixed into the second molding material R2 can advantageously be discharged efficiently and effectively in terms of the metering rotation count Np. Further, it is desirable that a purging speed Vp for purging operation be set to a higher speed than the purging speed Vs set for molding. This setting particularly contributes to optimization of the purging speed Vp for purging operation. Thus, a residue of the first molding material R1 mixed into the second molding material R2 can advantageously be discharged efficiently and effectively in terms of the purging speed Vp.

FIG. 5(c) shows results of the verification in terms of “presence or absence of empty purging,” specifically a result of the verification regarding the validity of empty purging. In this case, three types of samples including a sample No. SA9, a sample No. SA10, and a sample No. SA11 were used and the effect of this item was considered based on change of the length of “stroke” for empty purging. Referring to FIG. 5(c), the sample No. SA9 shows a case where a backward stroke for empty purging was set at 0, specifically where empty purging was not performed. Further, the sample No. SA10 shows a case where a backward stroke for empty purging was set at 10 [mm] and the sample No. SA11 shows a case where a backward stroke for empty purging was set at 50 [mm]. In consideration of the aforementioned verification results shown in FIGS. 5(a) and 5(b), the front side heating temperature Tf and the rear side heating temperature Tr were set at 250[° C.] and 180[° C.] respectively. Further, the purging speed Vp and the metering rotation count Np were set at 100 [mm/s] and 200 [rpm] respectively.

After the aforementioned purging process additionally including empty purging had finished, the screw 2 was taken out of the heating tube 3 and a residual amount was checked visually. As a result, as clearly seen from FIG. 5(c), the sample No. SA11 showed the most favorable result. Thus, performing empty purging is confirmed to be desirable to eliminate the residue of the first molding material R1 more readily. In particular, increasing the length of a backward stroke Xs as much as possible for empty purging was confirmed to achieve a more favorable result. Thus, as a guide for setting the backward stroke Xs for empty purging operation, it is desirable that the backward stroke Xs be set to be longer than at least a metering stroke Xm for metering purging process that will be described later, specifically the metering stroke (metering value) Xm by which the screw 2 is made to retreat by 10 [mm]. This setting particularly contributes to optimization of the backward stroke Xs for empty purging operation. Thus, a residue of the first molding material R1 mixed into the second molding material R2 can advantageously be discharged efficiently and effectively in terms of performing empty purging operation.

The validity of the resultant purging condition obtained in consideration of the aforementioned verification results is described below by referring to FIG. 4.

Residual resin relating to the first molding material R1 attached to the inner wall surface of the heating tube 3 is generally scraped off with a tip of the torpedo 2t, specifically with a ring valve 2tr in the outermost area when the screw 2 advances. Thus, when the second molding material R2 flows near the tip of the torpedo 2t, this residual resin is discharged with it. Fr in FIG. 4 shows the direction in which the second molding material R2 flows. For this reason, a higher heating temperature for the heating tube front section 3f and a higher purging speed are considered to facilitate discharge of the residual resin, specifically replacement of the residual resin with the second molding material R2 more effectively. Meanwhile, resin flows at a lower rate near the inner wall surface of the heating tube 3 than near the nozzle 5 and the head 4, so that the residual resin is not expected to be discharged effectively near the inner wall surface. Resin flows out of a gap of the ring valve 2tr to flow near the torpedo 2t during metering. However, this does not contribute to effective resin replacement and is not affected by the rotation count of the screw 2.

During the verification test, an inner wall temperature of the heating tube 3 and a surface temperature of the screw 2 were measured during metering operation. Then, it was found that the surface temperature measured while the screw 2 stops was slightly lower than the inner wall temperature of the heating tube, whereas the surface temperature measured during rotation of the screw 2 was reduced considerably by unmelted resin fed from the hopper 6. In consideration of these temperature states, a resin temperature near the torpedo 2t is assumed to be lower than a resin temperature near the screw tip 2s. The wettability of low-temperature resin in regards to a surface of metal is generally poor. Thus, the wettability of resin near the torpedo 2t placed in a relatively low temperature to a surface of the torpedo 2t (ring valve 2tr) is poor, so that this resin is considered to come off easily.

As a result, the following assumption can be made. As shown in FIGS. 4(a) to 4(c), when the screw 2 moves in the forward direction Ff, residual resin R1s attached to the screw tip 2s comes into contact with residual resin R1h attached to the inner wall of the head 4. When the screw 2 retreats, the residual resin R1s is expected to move toward the inner wall of the head 4. Thus, increasing accesses between the torpedo 2t and the head 4, specifically reducing a metering value and increasing a shot count (purging count) is considered to be an effective way to prompt this behavior mechanism to reduce usage of resin during the purging process. The validity of empty purging was confirmed, in particular, making the backward stroke Xs longer was confirmed to achieve a better result. Thus, enforcing the action of empty purging, specifically making the backward stroke Xs longer and performing empty purging a larger number of times is considered to be effective.

As seen from the foregoing, the screw tip 2s is a site where the residual resin R1s is hard to remove. Thus, in consideration of discharging the residual resin R1s on the screw tip 2s effectively, a metering condition (stroke condition) for the latter purging step was set. More specifically, the metering purging process was determined to be performed repeatedly a given number of times set as the situation demands. According to the metering purging process, metering of making the screw 2 retreat by 10 [mm] (metering value) is performed and then the screw 2 is made to advance. Additionally, the empty purging process was determined to be performed repeatedly a given number of times set as the situation demands. According to the empty purging process, the screw 2 is made to retreat by a given stroke and is then made to advance while the screw 2 is not rotated. Further, a series of purging operations including the aforementioned metering purging process and empty purging process in a set was determined to be performed repeatedly multiple times based on a set repeat count. The metering value (10 [mm]) for the metering purging process was set so as to be sufficiently smaller than the metering value (50 [mm]) for the former purging step. As a result, these settings were confirmed to be effective for reducing (removing) residual resin particularly in the torpedo 2t.

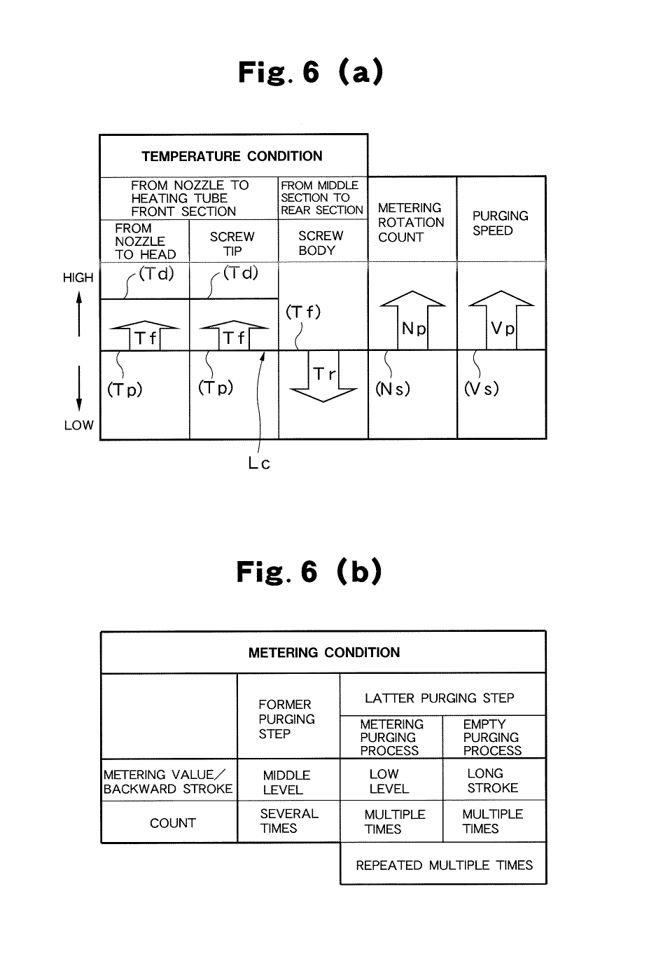

FIG. 6 collectively shows a way of setting a purging condition relating to the purging method during production, particularly relating to the switching purging step, based on the verification results shown in FIG. 4 and FIGS. 5(a) to 5(c). A line Lc in FIG. 6(a) shows a level to become a basis of comparison, such as a level of each molding condition set for molding.

FIG. 6(a) shows a setting condition. Regarding a heating temperature, the front side heating temperature Tf for the nozzle 5, the head 4, and the screw tip 2s, specifically for the front side including the heating tube front section 3f is set not to be lower than the heating temperature set for molding of the first molding material R1. The rear side heating temperature Tr for the screw body 2m, specifically for the site from the heating tube middle section 3m to the heating tube rear section 3r, is set to be lower than the front side heating temperature Tf. Meanwhile, the metering rotation count Np of the screw 2 for metering operation is set at a speed higher than that of the metering rotation count Ns set for molding. Further, the purging speed Vp of the screw 2 for purging operation is set to be higher than the purging speed Vs set for molding.

FIG. 6(b) shows a metering condition (stroke condition). A condition for the former purging step can be set by following a condition for a general purging process. As an example, for the former purging step, a metering value is set at a middle level and purging is only required to be performed several times. Meanwhile, the latter purging step is a relatively important purging step that is a principal part of the purging method of this embodiment. Specifically, the latter purging step corresponds to processes including the metering purging process and the empty purging process performed in combination. More specifically, for the metering purging process, a metering value is set at a low level and performed multiple times more than several times. For the empty purging process, the backward stroke Xs is set at a long stroke, desirably at 10 [mm] or more. Further, purging is to be performed multiple times more than several times. In this way, in consideration of a processing time, it is desirable that the backward stroke Xs be set to be longer and a shot count (purging count) be set to be larger for the empty purging process.

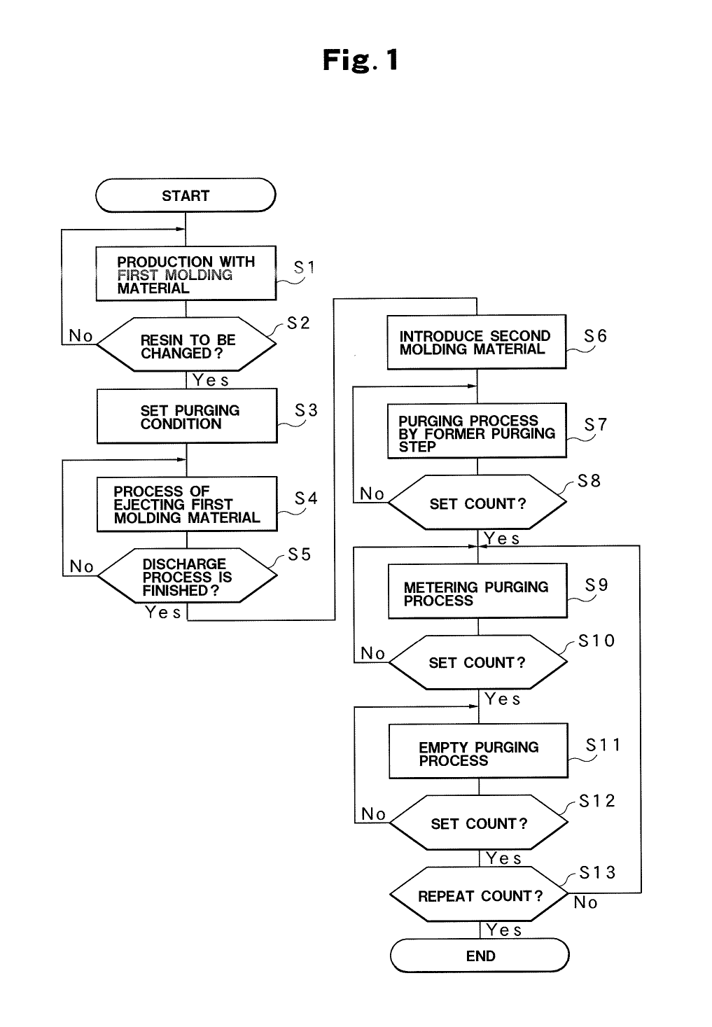

The purging method of this embodiment, giving consideration to the aforementioned verification results, is described next by referring to the flowchart of FIG. 1.

It is assumed that an article is being produced using the first molding material R1 (step S1). Then, the production using the first molding material R1 finishes and resin is to be changed, specifically a switch is made to production using the second molding material R2 in different color (step S2). Polypropylene resin is used as the first and second molding materials R1 and R2. Then, the purging process step based on the purging method of this embodiment is executed. In a brief outline, the material discharging step (steps S4 and S5) is executed to discharge the first molding material R1 left in the injection device 1i. Then, the purging process step is executed where the second molding material R2 different from the first molding material R1 is supplied to make a switch from the first molding material R1 to the second molding material R2 (steps S6 to S13). In this case, the material discharging step can be executed mainly by a common purging method of discharging the first molding material R1 remaining in the injection device 1i. Meanwhile, the switching purging step can be executed as a principal part of the purging method of this embodiment. The switching purging step is mainly intended to supply the second molding material R2 and make the second molding material R2 useable.

To execute the purging process step, various purging conditions are set first (step S3). The setting screen Dp shown in FIG. 3 is used for the setting. Setting for the material discharging step can be made in the first setting display part Dpa arranged in the upper side of the setting screen Dp. In the material discharging step of this embodiment described as an example, purging process is performed repeatedly five times. According to this purging process, metering of making the screw 2 retreat by 50 [mm] is performed and then the screw 2 is made to advance. Next, purging process is performed repeatedly until discharge of the first molding material R1 is complete. According to this purging process, metering of making the screw 2 retreat by 10 [mm] is performed and then the screw 2 is made to advance. Various settings required for these processes are made in the back pressure mode setting part 31, the metering rotation count setting part 32, the purging speed setting part 33, and the material shortage monitoring setting part 34 in the first setting display part Dpa, for example.

As described above, the metering rotation count setting part 32 and the purging speed setting part 33 are shared with the switching purging step, specifically with the former and latter purging steps. Thus, at this time, the metering rotation count Np is set at a speed higher than that of the metering rotation count Ns set for molding and the purging speed Vp is set to be higher than the purging speed Vs set for molding. As an example, the metering rotation count Np is set at 200 [rpm] and the purging speed Vp is set at 100 [mm/s] accordingly. A temperature condition for the material discharging step can exactly be the same as a heating temperature set for molding of the first molding material R1. Alternatively, a temperature condition for the former and latter purging steps may be used as the temperature condition for the material discharging step. If the temperature condition for the former and latter purging steps is used, the front side heating temperature Tf can be set at 250[° C.] and the rear side heating temperature Tr can be set at 180[° C.].

Next, a purging condition relating to the former and latter purging steps of the switching purging step is set. The second setting display part Dpb arranged in the lower side of the setting screen Dp and part of the first setting display part Dpa shown in FIG. 3 are used for this setting. A temperature condition for the former and latter purging steps is set such that the front side heating temperature Tf does not become lower than the heating temperature set for molding of the first molding material R1 and that the rear side heating temperature Tr becomes lower than the front side heating temperature Tf. A temperature setting screen not shown in the drawings is displayed to set the front side heating temperature Tf at 250[° C.] and the rear side heating temperature Tr at 180[° C.]. In this example, the front side heating temperature Tf can be controlled with the nozzle heater 11n, the head heater 11h, and the front heater 11f. In this example, the rear side heating temperature Tr can be controlled with the middle heater 11m and the rear heater 11f.

In the former purging step, metering operation and purging operation are performed repeatedly a given number of times. In the latter purging step executed after the former purging step is finished, a metering purging process and an empty purging process are performed a number of times corresponding to a given repeat count. According to this metering purging process, metering operation with a metering value smaller than that of the former purging step and purging operation are performed repeatedly a given number of times. According to this empty purging process, empty purging operation of making the screw retreat and then advance is repeated a given number of times while the screw is not rotated. Various settings required for these processes are made in the former purging step setting part 35, the metering purging process setting part 36, and the empty purging process setting part 37 in the second setting display part Dpb.

More specifically, a metering stop position (in this example, 50 [mm]) to become a metering value is set in the metering stop position setting part 35x and a purging count (in this example, five [times]) is set in the purging count setting part 35n of the former purging step setting part 35. Further, a metering stop position (in this example, 10 [mm]) to become a metering value is set in the metering stop position setting part 36x and a purging count (in this example, 20 [times]) is set in the purging count setting part 36n of the metering purging process setting part 36. Further, a metering stop position (in this example, 50 [mm]) to become a metering value is set in the metering stop position setting part 37x and a purging count (in this example, five [times]) is set in the purging count setting part 37n of the empty purging process setting part 37. A count of the latter purging step, specifically a repeat count of the entire metering purging processes and empty purging processes, is set in the repeat purging count setting part 38.

After the aforementioned settings are finished, a purging start key is turned on. In response, the process of discharging the first molding material R1 is performed first based on the material discharging step (step S4). Specifically, purging process is performed first repeatedly five times under the set purging condition. According to this purging process, metering of making the screw 2 retreat by 50 [mm] is performed and then the screw 2 is made to advance. Next, purging process is performed a set number of times. According to this purging process, metering of making the screw 2 retreat by 10 [mm] is performed and then the screw 2 is made to advance. In this way, the material discharging step for discharging the first molding material R1 from the injection device 1i is finished (step S5). As a result of executing this material discharging step, the process of discharging the first molding material R1 can be performed easily through commonly-used automatic purging process before the switching purging step is executed.

After the material discharging step is finished, the flow proceeds to the switching purging step. First, the second molding material R2 is introduced into the hopper 6 (step S6). Next, the former and latter purging steps are executed based on the set purging condition. In the former purging step, the purging process is performed repeatedly five times. According to this purging process, metering of making the screw 2 retreat by 50 [mm] is performed and then the screw 2 is made to advance. If the former purging step is executed a number of times corresponding to the set count, the flow shifts to the latter purging step (steps S7 and S8).

The latter purging step basically includes metering purging process and empty purging process as basic processes. In the metering purging process, purging operation is performed repeatedly 20 times. This purging operation is to perform metering of making the screw 2 retreat by 10 [mm] and then make the screw 2 advance. If the purging operation is performed a number of times corresponding to the set count, the flow shifts to the empty purging process (steps S9 and S10). In the empty purging process, purging operation is performed repeatedly five times. This purging operation is to perform metering of making the screw 2 retreat by 50 [mm] and then make the screw 2 advance (steps S11 and S12). The metering purging process and the empty purging process form a minor cycle in the latter purging step. This minor cycle is executed repeatedly a number of times corresponding to the set repeat count, specifically multiple times (steps S9 to S13). Then, the series of purging process steps based on the purging method of this embodiment is finished.

The purging method of this embodiment includes the switching purging step. The switching purging step includes the former purging step and the latter purging step executed after the former purging step. In the former purging step, after the second molding material R2 is introduced into the injection device 1i, metering operation and purging operation are repeated a given number of times. In the latter purging step, the metering purging process and the empty purging process are performed a number of times corresponding to a given repeat count. According to this metering purging process, metering operation with a metering value smaller than that of the former purging step and purging operation are repeated a given number of times. The empty purging process is performed after the metering purging process. According to this empty purging process, empty purging operation of making the screw retreat and then advance is repeated a given a number of times while the screw is not rotated. Thus, the residue of the first molding material R1 can be discharged efficiently and effectively from the injection device 1i. This achieves reduction in a purging processing time and contributes to reduction in material cost and enhancement of production efficiency.

The purging method of this embodiment and a purging method based on a conventional purging condition were compared. The result of the comparison particularly shows that a conventionally required resin amount of 12 [kg] or more can be reduced to about 3 [kg]. A reduction rate in this case is 75% or more, showing that material cost can be reduced significantly. Further, a time of about 110 [minutes] or more conventionally required for an entire purging process step can be reduced to about 50 [minutes]. A purging processing time can also be reduced significantly.

Regarding a set condition relating to a temperature in the switching purging step, the rear side heating temperature Tr for the site including the heating tube middle section 3m and the heating tube rear section 3r of the injection device 1i is set to be lower than the front side heating temperature Tf for the front side including the heating tube front section 3f. This allows optimization of a purging condition in terms of a temperature condition. This suppresses the occurrence of an unnecessary defective item, thereby reducing material cost further and shortening a purging processing time further.

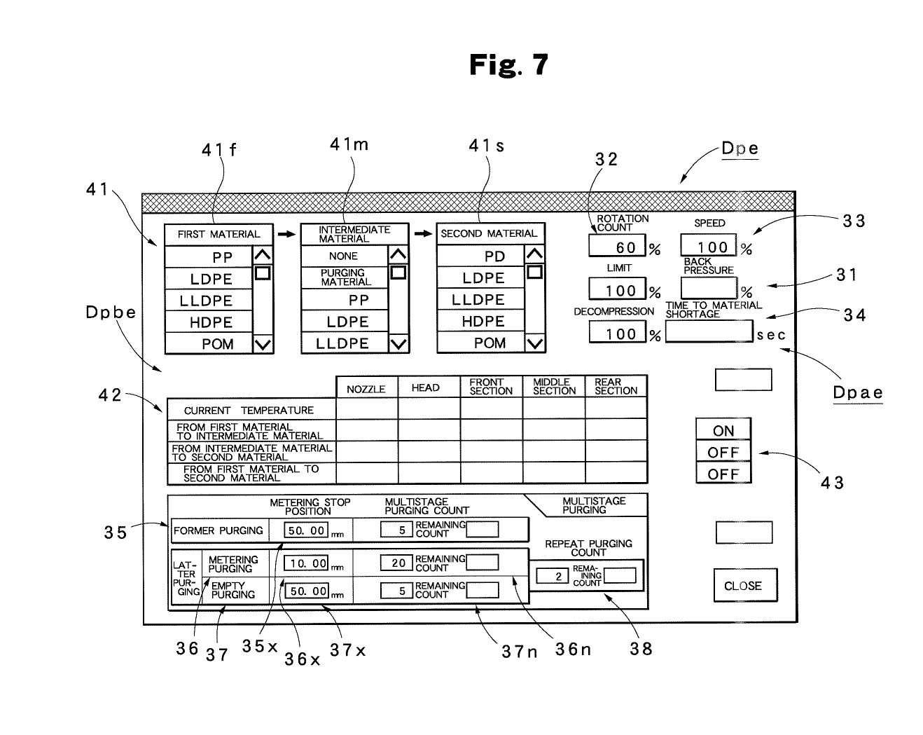

FIG. 7 shows a setting screen Dpe used in a purging process step based on a purging method of a modified embodiment. The setting screen Dpe of the modified embodiment is to facilitate setting responsive to various molding materials. Various types of resins are generally available as molding materials. Further, the properties of resin used as the first or second molding material R1 or R2 may differ largely in many cases. This makes setting, particularly of a temperature condition, in accordance with a combination of the first and second molding materials R1 and R2 difficult. In response, a database containing temperature conditions based on combinations of various molding materials is prepared in advance. This allows precise and reliable setting of a purging condition responsive to a combination easily and promptly.

The illustrated setting screen Dpe has the same basic structure as the setting screen Dp in that the setting screen Dpe includes a first setting display part Dpae similar to the aforementioned first setting display part Dpa and a second setting display part Dpbe similar to the aforementioned second setting display part Dpb. The setting screen Dpe differs from the setting screen Dp in that the setting screen Dpe additionally includes a resin selecting part 41, a temperature display part 42, and a purging mode selection key 43. The resin selecting part 41 includes a first molding material selecting part 41f, an intermediate material selecting part 41m, and a second molding material selecting part 41s. The first molding material R1 can be selected in the first molding material selecting part 41f. The second molding material R2 can be selected in the second molding material selecting part 41s. An intermediate material can be selected in the intermediate material selecting part 41m. The intermediate material is used if the first molding material R1 is not to be switched directly to the second molding material R2. The intermediate material is to be introduced once after the first molding material R1 is discharged and before the second molding material R2 is introduced. Depending on the type of resin, introducing the intermediate material can enhance discharge performance and switching efficiency, further resulting from switching between the first and second molding materials R1 and R2.

By selecting a material to be used in each of the first molding material selecting part 41f, the intermediate material selecting part 41m, and the second molding material selecting part 41s, a heating temperature determined optimally based on a combination of the selected materials is read from the database prepared in advance and displayed on the temperature display part 42. The type of a combination to be used can be selected with the purging mode selection key 43. Specifically, a temperature setting mode for switching from the first molding material R1 to the intermediate material, a temperature setting mode for switching from the intermediate material to the second molding material R2, and a temperature setting mode for switching from the first molding material R1 to the second molding material R2 can be selected by turning the purging mode selection key 43 ON or OFF. In this way, various settings and ways of use can be offered in various ways. As components of FIG. 7 that are the same as those of FIG. 3 are identified by the same signs to show their structures clearly, they will not be described in detail.

This invention is not limited to the preferred embodiment described in detail above. Any change, addition, or deletion is applicable to this invention in terms of its detailed structure, shape, material, quantity, numerical value, technique and the like within a range not departing from the substance of this invention.

As an example, metering operation and purging operation are repeated a given number of times in the material discharging step. Next, metering operation with a smaller metering value and purging operation are repeated a given number of times. However, this is not the only procedure possible. A different method is not to be eliminated if such a method is capable of discharging the first molding material R1. Further, it is desirable that the metering rotation count Np be set at a speed higher than that of the metering rotation count Ns set for molding and that the purging speed Vp be set to be higher than the purging speed Vs set for molding. However, these conditions are not essential. Further, polypropylene resin is used as an example in the embodiment of the purging method of this invention. However, the purging method of this invention is applicable to various types of resin materials.

### INDUSTRIAL APPLICABILITY

The purging method of this invention is applicable to various types of injection molding machines capable of executing a purging process step of switching resin to be used for molding from a first molding material to a different second molding material.

### REFERENCE SIGNS LIST

1: Injection molding machine, 1i: Injection device, 3m: Heating tube middle section, 3r: Heating tube rear section, 3f: Heating tube front section, R1: First molding material, R2: Second molding material, Tr: Rear side heating temperature, Tf: Front side heating temperature, Tp: Processing temperature for resin, Td: Decomposition temperature for resin, (S4): Material discharging step, (S7): Former purging step, (S9): Metering purging process, (S11): Empty purging process, (S9 to S13): Latter purging step, (S6 to S13): Switching purging step, Np: Metering rotation count, Ns: Set metering count, Vp: Purging speed, Vs: Set purging speed, Dp (Dpe): Setting screen, Dpa (Dpae): First setting display part, Dpb (Dpbe): Second setting display part

### CITATION LIST

Patent Literature 1

JP-No. H11 (1999)-28753

Patent Literature 2

JP-No. 2008-195023

1. A method of purging for an injection molding machine employed for making a switch from a first molding material to a second molding material different from the first molding material by discharging a residue of the first molding material from an injection device and supplying the second molding material, the purging method comprising a switching purging step as a purging process step executed after the residual first molding material is discharged in advance from the injection device by a certain method, the switching purging step comprising a former purging step and a latter purging step executed after the former purging step, the former purging step including introduction of the second molding material into the injection device, and a metering operation and purging operation repeated a given number of times, the latter purging step including metering purging process and empty purging process performed a number of times corresponding to a given repeat count, the metering purging process including metering operation with a metering value smaller than that of the former purging step and purging operation repeated a given number of times, the empty purging process being performed after the metering purging process, the empty purging process including empty purging operation of making a screw retreat and then advance while the screw is not rotated, the empty purging operation being repeated a given number of times.

2. The method of purging for an injection molding machine according to claim 1, wherein, in the switching purging step, regarding a set condition relating to a temperature, a rear side heating temperature for a site including a heating tube middle section and a heating tube rear section of the injection device is set to be lower than a front side heating temperature for a front side including a heating tube front section.

3. The method of purging for an injection molding machine according to claim 2, wherein the front side heating temperature is set in a range from not lower than a processing temperature for resin relating to the first and second molding materials to not higher than a decomposition temperature of the resin.

4. The method of purging for an injection molding machine according to claim 2, wherein the rear side heating temperature is set to be the same as a melting point of resin relating to the first and second molding materials or higher.

5. The method of purging for an injection molding machine according to claim 1, wherein, in the switching purging step, a metering rotation count for the metering operation is set at a speed higher than that of a metering rotation count set for molding.

6. The method of purging for an injection molding machine according to claim 1, wherein, in the switching purging step, a purging speed for the purging operation is set to be higher than a purging speed set for molding.

7. The method of purging for an injection molding machine according to claim 1, wherein in the latter purging step, a backward stroke in the empty purging process is set to be longer than a metering stroke for the metering purging process.

8. The method of purging for an injection molding machine according to claim 1, wherein, for discharge of the first molding material remaining in the injection device, an discharge process is performed by a material discharging step under a set purging condition.

9. The method of purging for an injection molding machine according to claim 8, wherein an intermediate material is introduced after the material discharging step has finished and before the second molding material is supplied.

10. The method of purging for an injection molding machine according to claim 9, wherein, in the purging process step, a first setting display part corresponding to the material discharging step and a second setting display part corresponding to the switching purging step are displayed on a setting screen.

11. The method of purging for an injection molding machine according to claim 10, wherein at least one or more of a resin selecting part, including a choice for the intermediate material, a temperature display part, and a purging mode selection key is displayed on the setting screen in addition to the first and second setting display parts.

12. The method of purging for an injection molding machine according to claim 3, wherein the rear side heating temperature is set to be the same as a melting point of resin relating to the first and second molding materials or higher.
